(19) United States
(12) Patent Application Publication
(10) Pub. No.: US 2017/0052836 A1
(43) Pub. Date: Feb. 23, 2017

(54) METHOD FOR PREDICTING A FAULT IN A CABIN TEMPERATURE CONTROL SYSTEM OF AN AIRCRAFT

(71) Applicant: Taleris Global LLP, Cheltenham Gloucestershire (GB)

(72) Inventors: Robert William HORABIN, Eastleigh, Hampshire (GB); Julia Ann HOWARD, Eastleigh, Hampshire (GB); Frank BEAVEN, Eastleigh, Hampshire (GB)

(21) Appl. No.: 15/119,995

(22) PCT Filed: Feb. 21, 2014
(86) PCT No.: PCT/GB2014/050511

§ 371 Date: Aug. 18, 2016

(51) Int. Cl. G06F 11/00; G06F 11/30; G06F 11/32; F24F 11/00

(52) U.S. Cl. CPC G06F 11/004; F24F 11/0009; G06F 11/3013; G06F 11/3058; G06F 11/3089; G06F 11/324; G06F 2201/805; G06F 2201/86

(57) ABSTRACT

A method of predicting a fault in a cabin temperature control system of an air-conditioning system of an aircraft is disclosed. The method includes transmitting data related to a temperature, pressure, valve position, or actuator position of the cabin temperature control system, comparing the transmitted data to a reference value, and predicting a fault in the cabin temperature control system based on the comparing.

### BACKGROUND

Contemporary aircrafts have air-conditioning systems that take hot air from the engines of the aircraft for use within the aircraft, including use in a cabin of the aircraft. A cabin temperature control system may be utilized for controlling temperatures within the cabin. Currently, airlines and maintenance personnel wait until a fault or problem occurs with the cabin temperature control system and then attempt to identify the cause and fix it during either scheduled or, more likely, unscheduled maintenance. Fault occurrences are also recorded manually based on pilot discretion.

### BRIEF DESCRIPTION

Embodiments generally relate to a method of predicting a fault in a cabin temperature control system of an air-conditioning system of an aircraft, wherein the method includes transmitting data related to a temperature, pressure, valve position, or actuator position of the cabin temperature control system, comparing the transmitted data to a reference value, predicting a fault in the cabin temperature control system based on the comparing, and providing an indication of the predicted fault.

### BRIEF DESCRIPTION OF THE DRAWINGS

In the drawings:

FIG. 1 is a perspective view of an aircraft and a ground system in which embodiments may be implemented;

FIG. 2 is a schematic view of a portion of an exemplary air-conditioning system;

FIG. 3 is a schematic view of a portion of an exemplary air-conditioning system; and

FIG. 4 is a flowchart showing a method of predicting a fault in a cabin temperature control system according to an embodiment.

### DETAILED DESCRIPTION

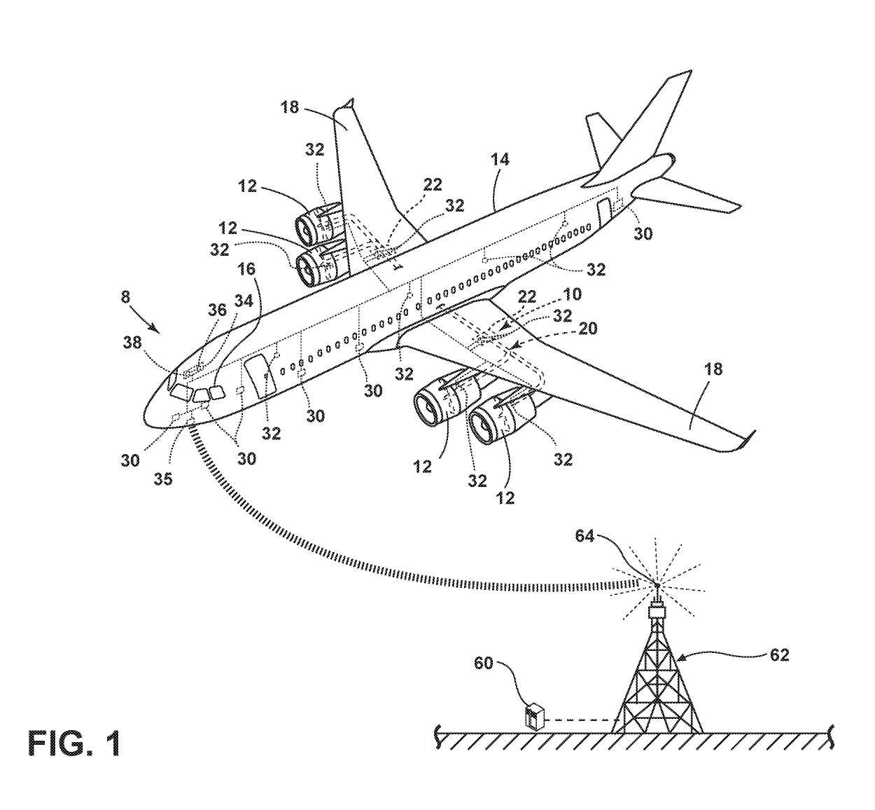

FIG. 1 illustrates an aircraft 8 that may include an air-conditioning system 10, only a portion of which has been illustrated for clarity purposes, and may execute embodiments disclosed herein. As illustrated, the aircraft 8 may include multiple engines 12 coupled to a fuselage 14, a cockpit 16 positioned in the fuselage 14, and wing assemblies 18 extending outward from the fuselage 14. While a commercial aircraft has been illustrated, embodiments may be used in any type of aircraft, for example, without limitation, fixed-wing, rotating-wing, rocket, personal aircraft, and military aircraft. Further, while two engines 12 have been illustrated on each wing assembly 18, it will be understood that any number of engines 12 including a single engine 12 may be included.

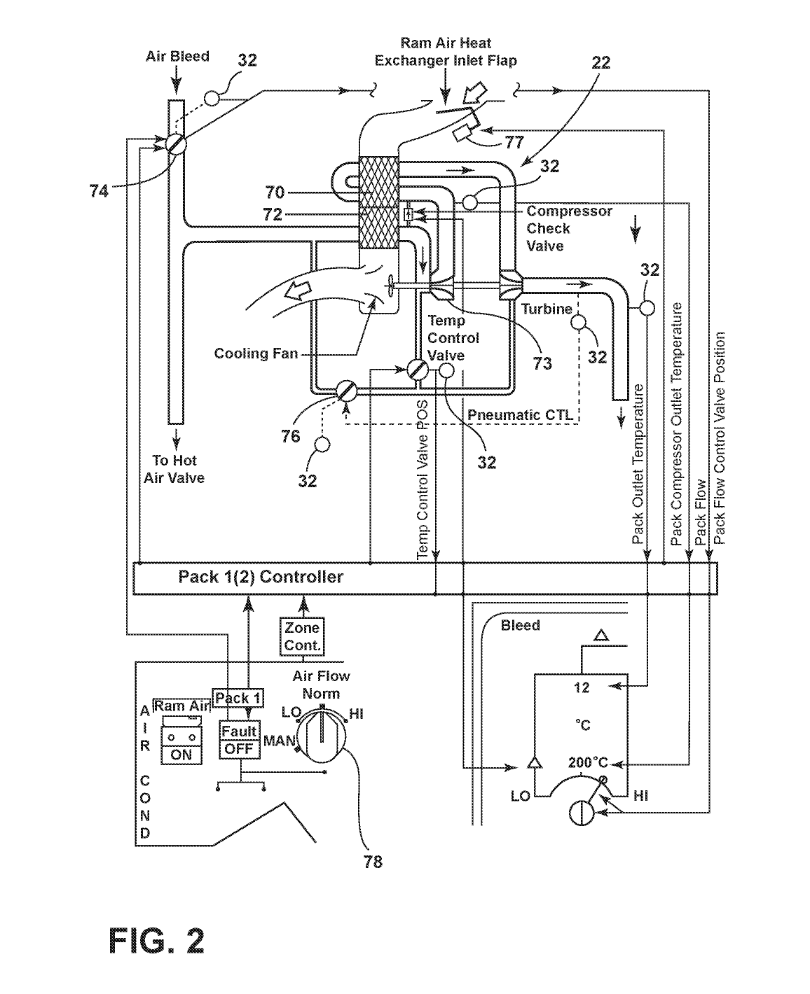

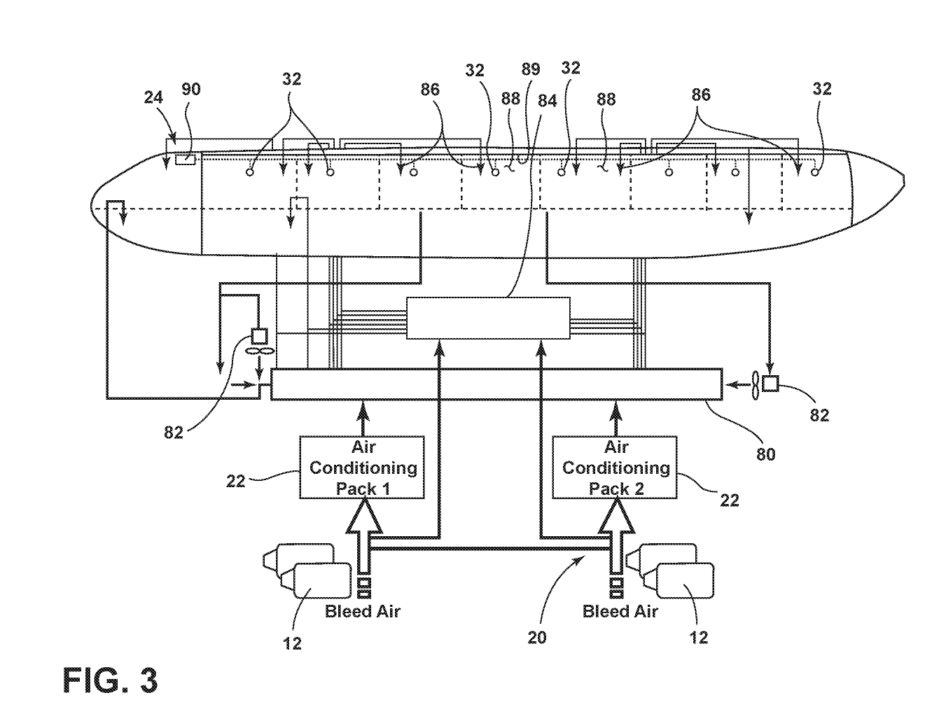

The air-conditioning system 10 may form a portion of the environmental control system of the aircraft 8 and may include a variety of subsystems. For example, among others, a bleed air system 20, one or more air-conditioning packs 22, and an air distribution or cabin temperature control system 24 (FIG. 3) may be included in the air-conditioning system 10. The bleed air system 20 may be connected to each of the engines 12 and air may be supplied to the air-conditioning system 10 by being bled from a compressor stage of each engine 12, upstream of the combustor. Various bleed ports may be connected to various portions of the engine 12 to provide highly compressed air to the bleed air system 20. The temperature and pressure of this bleed air varies widely depending upon which compressor stage and the RPM of the engine 12. The air-conditioning packs 22 and cabin temperature control system 24 will be described in more detail with respect to FIGS. 2 and 3 below.

A plurality of additional aircraft systems 30 that enable proper operation of the aircraft 8 may also be included in the aircraft 8. A number of sensors 32 related to the air-conditioning system 10, its subsystems, and the additional aircraft systems 30 may also be included in the aircraft 8. It will be understood that any number of sensors may be included and that any suitable type of sensors may be included. The sensors 32 may transmit various output signals and information.

A controller 34 and a communication system having a wireless communication link 35 may also be included in the aircraft 8. The controller 34 may be operably coupled to the air-conditioning system 10, the plurality of aircraft systems 30, as well as the sensors 32. The controller 34 may also be connected with other controllers of the aircraft 8. The controller 34 may include memory 36, the memory 36 may include random access memory (RAM), read-only memory (ROM), flash memory, or one or more different types of portable electronic memory, such as discs, DVDs, CD-ROMs, etc., or any suitable combination of these types of memory. The controller 34 may include one or more processors 38, which may be running any suitable programs. The controller 34 may be a portion of an FMS or may be operably coupled to the FMS.

A computer searchable database of information may be stored in the memory 36 and accessible by the processor 38. The processor 38 may run a set of executable instructions to display the database or access the database. Alternatively, the controller 34 may be operably coupled to a database of information. For example, such a database may be stored on an alternative computer or controller. It will be understood that the database may be any suitable database, including a single database having multiple sets of data, multiple discrete databases linked together, or even a simple table of data. In an embodiment, the database may incorporate a number of databases or that the database may actually be a number of separate databases. The database may store data that may include historical air-conditioning system data for the aircraft 8 and be related to a fleet of aircraft. The database may also include reference values including predetermined threshold values, historic values, or aggregated values and data related to determining such values.

Alternatively, the database may be separate from the controller 34 but may be in communication with the controller 34 such that it may be accessed by the controller 34. For example, in an embodiment, the database may be contained on a portable memory device and in such a case, the aircraft 8 may include a port for receiving the portable memory device and such a port would be in electronic communication with controller 34 such that controller 34 may be able to read the contents of the portable memory device. In an embodiment, the database may be updated through the wireless communication link 35 and in this manner, real time information may be included in the database and may be accessed by the controller 34.

Further, in an embodiment, such a database may be located off the aircraft 8 at a location such as an airline operation center, flight operations department control, or another location. The controller 34 may be operably coupled to a wireless network over which the database information may be provided to the controller 34.

While a commercial aircraft has been illustrated, portions of the embodiments may be implemented anywhere including in a computer or controller 60 at a ground system 62. Furthermore, the database(s) as described above may also be located in a destination server or a controller 60, which may be located at and include the designated ground system 62. Alternatively, the database may be located at an alternative ground location. The ground system 62 may communicate with other devices including the controller 34 and databases located remote from the controller 60 via a wireless communication link 64. The ground system 62 may be any type of communicating ground system 62 such as an airline control or flight operations department.

FIG. 2 illustrates an exemplary schematic view of a cold air unit also known as an air-conditioning pack 22 having a main heat exchanger 70, a primary heat exchanger 72, compressor 73, a flow control valve 74, a turbine 75, an anti-ice valve 76, a ram air inlet flap actuator 77, and a controller 78, which may be located within the cockpit 16 of the aircraft 8 and may be operably coupled to the controller 34. Further, a number of sensors 32 have been illustrated as being included within the air-conditioning pack 22. The sensors 32 may output a variety of data including data related to temperatures of the air-conditioning pack 22, pressures of the air-conditioning pack 22, or valve positions. For example, some of the sensors 32 may output various parameters including binary flags for indicating valve settings and/or positions including for example the state of the valve (e.g. fully open, open, in transition, close, fully closed).

It will be understood that any suitable components may be included in the air-conditioning pack 22 such that it may act as a cooling device. The quantity of bleed air flowing to the air-conditioning pack 22 is regulated by the flow control valve 74. The bleed air enters the primary heat exchanger 72 where it is cooled by either ram air, expansion, or a combination of both. The cold air then enters the compressor 73, where it is re-pressurized, which reheats the air. A pass through the main heat exchanger 70 cools the air while maintaining the high pressure. The air then passes through the turbine 75, which expands the air to further reduce heat.

FIG. 3 illustrates an exemplary diagram of a cabin temperature control system 24 having a mixer unit 80, recirculation fans 82, a manifold 84, and nozzles 86 that distribute air into zones 88 within the cabin 89 of the aircraft 8, as well as a control mechanism 90. As illustrated, exhaust air from the air-conditioning packs 22 may be mixed in a mixer unit 80 with filtered air from the recirculation fans 82 and fed into a manifold 84. Air from the manifold 84 may be directed through ducts to overhead distribution nozzles 86 in the various zones 88 of the aircraft 8. Cabin temperature regulating valves also known as trim air valves (not shown) may be utilized to control the flow of air through the distribution nozzles 86. A control mechanism 90 may control the temperature in each zone 88 as well as a variety of other aspects of the cabin temperature control system 24. It will be understood that the control mechanism may be operably coupled to the controller 34. A number of sensors 32 may be included and may output signals related to various aspects of the cabin temperature control system 24 including temperatures within the zones 88, pressures within the cabin temperature control system 24, temperatures of physical portions of the cabin temperature control system 24 including duct temperatures, etc.

It will be understood that the controller 34 and the controller 60 merely represent two exemplary embodiments that may be configured to implement embodiments or portions of embodiments. During operation, either the controller 34 and/or the controller 60 may predict a fault with the cabin temperature control system 24. By way of non-limiting example, one or more sensors 32 may transmit data relevant to various characteristics of the air-conditioning system 10. The controller 34 and/or the controller 60 may utilize inputs from the control mechanisms, sensors 32, aircraft systems 30, the database(s), and/or information from airline control or flight operations department to predict the fault with the cabin temperature control system 24. Among other things, the controller 34 and/or the controller 60 may analyze the data over time to determine drifts, trends, steps, or spikes in the operation of the air-conditioning system 10. The controller 34 and/or the controller 60 may also analyze the sensor data and predict faults in the air-conditioning system 10 based thereon. Once a fault with the cabin temperature control system 24 has been predicted an indication may be provided on the aircraft 8 and/or at the ground system 62. In an embodiment, the predicting of the fault with the air-conditioning system 10 or a subsystem thereof may be done during flight, may be done post flight, or may be done after any number of flights. The wireless communication link 35 and the wireless communication link 64 may both be utilized to transmit data such that the fault may be predicted by either the controller 34 and/or the controller 60.

One of the controller 34 and the controller 60 may include all or a portion of a computer program having an executable instruction set for predicting cabin temperature control system fault in the aircraft 8. Such predicted faults may include improper operation of components as well as failure of components of the cabin temperature control system 24. As used herein the term prediction refers to a forward-looking determination that makes the fault known in advance of when the fault occurs and contrasts with detecting or diagnosing, which refers to a determination after the fault has occurred. Along with predicting the controller 34 and/or the controller 60 may detect the fault. Regardless of whether the controller 34 and/or the controller 60 runs the program for predicting the fault, the program may include a computer program product that may include machine-readable media for carrying or having machine-executable instructions or data structures stored thereon.

It will be understood that details of environments that may implement embodiments are set forth in order to provide a thorough understanding of the technology described herein. It will be evident to one skilled in the art, however, that the exemplary embodiments may be practiced without these specific details. The exemplary embodiments are described with reference to the drawings. These drawings illustrate certain details of specific embodiments that implement a module or method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system. Further, multiple computers or processors may be utilized including that the controller 34 and/or the controller 60 may be formed from multiple controllers. It will be understood that the controller predicting the fault may be any suitable controller including that the controller may include multiple controllers that communicate with each other.

As noted above, embodiments described herein may include a computer program product including machine-readable media for carrying or having machine-executable instructions or data structures stored thereon. Such machine-readable media may be any available media, which may be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium that can be used to carry or store desired program codes in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data, which cause a general-purpose computer, special purpose computer, or special purpose processing machines to perform a certain function or group of functions.

Embodiments will be described in the general context of method steps that may be implemented in one embodiment by a program product including machine-executable instructions, such as program codes for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

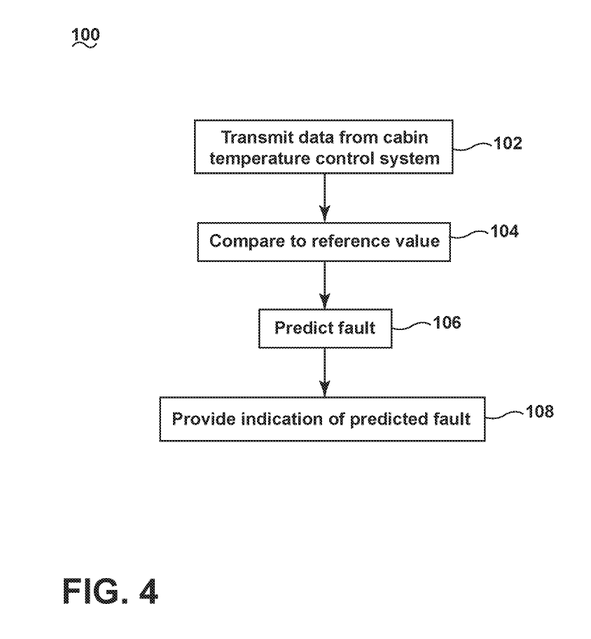

In accordance with an embodiment, FIG. 4 illustrates a method 100, which may be used for predicting a fault in the cabin temperature control system 24 of the air-conditioning system 10; such a predicted fault may include a predicted failure. The method 100 begins at 102 by transmitting from one or more sensors 32 data related to the cabin temperature control system 24. More specifically, data may be transmitted from one or more sensors 32 outputting data related to temperatures, pressures or flow rates, valve positions, actuator positions, etc. for components of the cabin temperature control system 24. This may include sequentially and/or simultaneously transmitting data from one or more of the sensors 32. The transmitted data may be received by any suitable device including a database or the controller 34 and/or the controller 60.

The transmitting of data at 102 may define sensor output(s) relevant to one or more characteristics of the cabin temperature control system 24. In an embodiment, the sensor output(s) may include raw data from which a variety of other information may be derived or otherwise extracted to define the sensor output. It will be understood that regardless of whether the sensor output is received directly or derived from received output, the output may still be considered sensor output. For example, the sensor output may be aggregated over time to define aggregated sensor data. Aggregating the transmitted sensor output over time may include aggregating the transmitted sensor output over multiple phases of flight and/or over multiple flights. Such aggregated sensor data may include a median value, a maximum value, a minimum value, etc. Such aggregated sensor data may be reset after a maintenance event.

At 104, the transmitted data or sensor output may be compared to a reference value for the transmitted data. The reference value may be any suitable reference value related to the transmitted data including that the reference value may be a temperature value, a pressure value, an acceptable valve, actuator position range, etc. The reference value for the transmitted data may also include a predetermined threshold, historical values, a value that has been determined during operation, etc. Alternatively, the reference values may be stored in one of the database(s) as described above.

In this manner, the sensor output may be compared to a predetermined threshold for the sensor output. Any suitable comparison may be made. For example, the comparison may include determining a difference between the sensor output and the predetermined threshold. By way of non-limiting example, the comparison may include comparing a recent signal output to a historic value. Comparisons may be made on a per flight basis or the data may be processed over a series of flights. Comparisons may further measure a change in correlation between two parameters including where the correlation exceeds a given threshold. In the case where median values are calculated for the transmitted data, the comparing at 104 may include comparing the median value to the predetermined threshold. Further still when minimums and maximums for the transmitted data may be determined, the comparing at 104 may include comparing the minimums and/or maximums to the predetermined thresholds.

At 106, a fault in the cabin temperature control system 24 may be predicted based on the comparison at 104. More specifically, a fault of a valve, sensor, or controller in the cabin temperature control system 24 may be predicted based on the comparison at 104. For example, a fault in the cabin temperature control system 24 of the air-conditioning system 10 may be predicted when the comparison indicates that the sensor data satisfies a predetermined threshold. The term “satisfies” the threshold is used herein to mean that the variation comparison satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted.

Any number of faults in the cabin temperature control system 24 of the air-conditioning system 10 may be determined. By way of non-limiting example, transmitting the data at 102 may include transmitting a cabin temperature regulating valve position. In such an instance, a fault may be predicted with the cabin temperature regulating valve when the comparison indicates more air passes through the cabin temperature regulating valve over time or the comparison indicates that its position is increasing over time. Currently, such a fault may only be detected through increased occurrences of passenger/cabin staff reports of, typically, hot cabin compartment temperatures, despite the set temperature being low. Only after multiple occurrences, where resets of the cabin temperature control system 24 have not worked, does further investigation take place by maintenance personnel. Also, the mixing of air throughout the cabin 89 means that a fault with a cabin temperature regulating valve can go unnoticed as correctly conditioned air from other zones 88 dilutes the impact.

Sensor faults may be determined by determining a high number of out of range readings. It will be understood that any number of faults may be predicted based on any number of comparisons. These comparisons may also be used to provide information relating to the severity of the fault.

In this manner, the transmitted data may undergo analysis in relation to themselves and to other parameters/features and this information may be used to determine impending faults and/or degradation and provide associated information such as severity and prognostic information by highlighting an impending failure of a particular component. It will be understood that any suitable controller or computer may perform one or more portions of the method 100. For example, the controller 34 and/or the controller 60 may compare the transmitted data, predict the fault, and provide the indication. The controller may utilize an algorithm to predict the fault. In implementation, the predetermined thresholds and comparisons may be converted to an algorithm to predict faults in the cabin temperature control system 24 of the air-conditioning system 10. Such an algorithm may be converted to a computer program including a set of executable instructions, which may be executed by the controller 34 and/or the controller 60. Alternatively, the computer program may include a model, which may be used to predict faults in the cabin temperature control system 24. The model may be implemented in software as an algorithm, such as one or more mathematical algorithms.

At 108, the controller 34 and/or the controller 60 may provide an indication of the fault in the cabin temperature control system 24 predicted at 106. The indication may be provided in any suitable manner at any suitable location including in the cockpit 16 and at the ground system 62. For example, the indication may be provided on a primary flight display (PFD) in a cockpit 16 of the aircraft 8. If the controller 34 ran the program, then the indication may be provided on the aircraft 8 and/or may be uploaded to the ground system 62. Alternatively, if the controller 60 ran the program, then the indication may be uploaded or otherwise relayed to the aircraft 8. Alternatively, the indication may be relayed such that it may be provided at another location such as an airline control or flight operations department.

It will be understood that the method of predicting a fault in the cabin temperature control system 24 is flexible and the method illustrated is merely for illustrative purposes. For example, the sequence of steps depicted is for illustrative purposes only, and is not meant to limit the method 100 in any way, as it is understood that the steps may proceed in a different logical order or additional or intervening steps may be included without detracting from embodiments. For example, in an embodiment, predicting the fault at 106 may be based on multiple comparisons at 104. For example, one type of sensor data may be transmitted multiple times and the comparisons may compare the data to a predetermined threshold such as a control limit. In this manner, the multiple comparisons may be made over time. Alternatively, the multiple comparisons may be made with multiple types of sensor data or from sensor data from across the aircraft. By way of non-limiting example, transmitting the data at 102 may include transmitting a cabin temperature regulating valve position and a temperature from at least one temperature sensor 32 operably coupled to the air-conditioning system 10. The reference value that the transmitted temperature may be compared to may include a set temperature. The comparing at 104 may include determining a difference between the transmitted temperature and the set temperature and comparing that difference to a temperature reference difference value. A fault with the cabin temperature regulating valve may be predicted when the comparisons indicate the valve position is increasing and the difference satisfies the temperature reference value. More specifically, the comparisons may indicate increased duct temperatures and increased cabin compartment temperatures for a particular zone 88 and such comparisons may be used to predict a fault with a particular cabin temperature regulating valve. Furthermore, in an embodiment, the temperature reference value may be determined by the controller 34 and/or the controller 60. More specifically, deltas between set and actual temperatures as well as deltas between adjacent zones may also be determined. Comparisons with such values may allow the abnormal behavior to be more clearly identified from the normal variation present in the operation of the system. For example, a cabin temperature identified as abnormally hot might be rationalized/nullified if the corresponding set temperature is high or if the adjacent zones are similarly hot, due to, for example, extreme ambient temperatures. By way of a further non-limiting example, a pack outlet temperature, outside air temperature, and cabin set temperature may be transmitted at 102. In such an instance, a fault with the cabin temperature regulating valve may be predicted at 106 when the comparisons at 104 indicate the valve position is increasing and the transmitted temperatures are within normal bounds. In this manner, the fault may be isolated to the cabin temperature regulating valve.

By way of a further example, in an embodiment, the transmitted data may include data from a plurality of flights, including the pre-flight and/or cruise portions of such plurality of flights. In such an instance, comparing the transmitted data may include comparing the data from the plurality of flights with related predetermined threshold(s). In this manner, multiple comparisons may be made utilizing the data for the plurality of flights. Further, predicting the fault may include predicting the fault when the comparisons indicate the predetermined thresholds are satisfied a predetermined number of times and/or over a predetermined number of flights.

Potentially beneficial effects of the above-described embodiments include that data gathered by the aircraft may be utilized to predict a fault in the cabin temperature control system. This allows such predicted faults to be corrected before they occur. For example, a leak in a duct can be indicated by a change in the temperature sensor data for the duct relative to past performance under the same or similar environmental conditions. Currently there is no manner to predict faults in the cabin temperature control system and unanticipated issues occurring during aircraft usage or even known issues, which require unplanned maintenance actions, lead to potential operational impacts for an airline. The above-described embodiments enable reduction of operational impacts, including a reduction in delays for passengers and in the level of unscheduled maintenance required as a result of air-conditioning system faults. The above-described embodiments also help with planning of scheduled maintenance due to prognostic information supplied. The above-described embodiments allow for automatic predicting and alerting to users of faults. The above-embodiments allow accurate predictions to be made regarding faults in the cabin temperature control system and by predicting such problems, sufficient time may be allowed to make repairs before such faults occur. This allows for cost savings by reducing maintenance cost, rescheduling cost, and minimizing operational impacts including minimizing the time aircraft are grounded.

This written description uses examples to disclose the embodiments, including the best mode, and also to enable any person skilled in the art to practice the embodiments, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of predicting a fault in a cabin temperature control system of an air-conditioning system of an aircraft, wherein the cabin temperature control system includes one or more sensors, the method comprising:
transmitting, from a sensor operably coupled to the cabin temperature control system, data related to a temperature, pressure, valve position, or actuator position of the cabin temperature control system;
comparing the transmitted data to a reference value;
predicting, by a controller, a fault of a valve, sensor, or controller in the cabin temperature control system based on the comparing; and
providing an indication of the predicted fault.

2. The method of claim 1, wherein transmitting the data comprises transmitting a cabin temperature regulating valve position.

3. The method of claim 2, wherein predicting the fault comprises predicting a fault with a cabin temperature regulating valve when the comparing indicates that the amount of air passing through the cabin temperature regulating valve is increasing over time.

4. The method of claim 2, wherein predicting the fault is based on multiple comparisons of the transmitted data to a reference value.

5. The method of claim 4, wherein transmitting the data further comprises transmitting a temperature from at least one temperature sensor operably coupled to the air-conditioning system.

6. The method of claim 5, wherein the reference value is a set temperature.

7. The method of claim 6, wherein the comparing comprises determining a difference between the transmitted temperature and the set temperature and comparing the difference to a temperature reference difference value.

8. The method of claim 7, wherein predicting the fault comprises predicting a fault with the cabin temperature regulating valve when the comparing indicates the valve position is increasing and the difference between the transmitted temperature and the set temperature satisfies the temperature reference value.

9. The method of claim 7, further comprising determining the temperature reference difference value.

10. The method of claim 9, wherein predicting the fault comprises predicting a fault with the cabin temperature regulating valve when the comparing indicates the valve position is increasing and the difference between the transmitted temperature and the set temperature satisfies the temperature reference value.

11. The method of claim 5, wherein a pack outlet temperature, outside air temperature, and cabin set temperature are transmitted.

12. The method of claim 11, wherein predicting the fault comprises predicting a fault with the cabin temperature regulating valve when the comparing indicates the valve position is increasing and the transmitted temperatures are within normal bounds.

13. The method of claim 1, wherein the indication is provided on a display of the aircraft.

14. The method of claim 1, wherein a controller of the aircraft compares the data to the reference value, predicts the fault, and provides the indication.

15. The method of claim 14, wherein the controller utilizes an algorithm to predict the fault.

16. The method of claim 8, further comprising determining the temperature reference difference value.
